(19) United States
(12) Patent Application Publication
(10) Pub. No.: US 2011/0202545 A1
(43) Pub. Date: Aug. 18, 2011

(54) INFORMATION EXTRACTION DEVICE AND INFORMATION EXTRACTION SYSTEM

(76) Inventors: Takao Kawai, Tokyo (JP); Shinichi Ando, Tokyo (JP)

(21) Appl. No.: 12/811,861

(22) PCT Filed: Jan. 6, 2009
(86) PCT No.: PCT/JP2009/050039

§ 371 Date: Jul. 27, 2010

(30) Foreign Application Priority Data
Jan. 7, 2008 (JP) 2008000685

(51) Int. Cl. G06F 17/30

(52) U.S. Cl. 707/755; 707/E17.009

(57) ABSTRACT

The information extraction device for extracting specific information using information extraction rules comprises a case candidate extraction means for extracting new specific information that is not extracted by the information extraction rules as novel case candidates based on extraction results obtained from extraction target text data; a rule candidate generation means for generating multiple extraction rule candidates based on the novel case candidates; a relation analysis means for analyzing the derivational relation between the novel case candidates and the extraction rule candidates and the overlapping relation between the multiple extraction rule candidates to generate relation analysis results; and a case candidate selection means for calculating the priorities of the novel case candidates based on the relation analysis results and previously prepared case information and selecting the novel case candidates according to the priority.

### TECHNICAL FIELD

The present invention relates to an information extraction device and information extraction system and more specifically to an information extraction device and information extraction system for selecting cases used to generate information extraction rules applied to extractions of specific information from extraction target text data. The present invention further relates to an information extraction method and information extraction program used in such a device and system.

### BACKGROUND ART

Information extraction devices are used for extracting specific information from a large volume of extraction target text data. In an information extraction device, for example, information extraction rules using patterns in text data and various statistic criteria are generated based on cases prepared in advance and the information extraction rules are applied to text data to extract specific information from the text data.

Generally, an information extraction device does not always successfully extract desired specific information from text data; for example, extraction failure or erroneous extraction may occur. Therefore, in order to generate highly accurate information extraction rules, many “correct cases” that are not extracted by applying the information extraction rules to text data have to be prepared. For convenience, “correct cases” are referred to as positive cases and “incorrect cases” are referred to as negative cases hereafter. Here, positive cases are cases of which the content is information suitable for extraction based on, for example, key words and the like given by the user. Similarly, negative cases are cases of which the content is information unsuitable for extraction. However, positive and negative cases are absolutely distinguished in accordance with given key words and the like and interchangeable according to key words and the like.

In order to prepare positive cases, information that is not extracted by applying information extraction rules to text data has to be found and searched for. If this finding operation is done by a person, huge workload is imposed on the worker and higher cost is required.

Patent Literature 1 describes an information extraction device comprising a storage means, a learning means, an inquiry means, and a control means. The storage means stores information regarding a set of text data in which a small number of positive cases are tagged. The learning means generates information extraction rules with reference to information stored in the storage means and deduces the categories of tags along with a certainty factor from characteristics of text data that are not tagged. The inquiry means inquires of the user whether or not the deduction results by the learning means are correct and receives answers from the user. The control means determines the categories of tags for the text data that are not tagged based on the answers and adds information on the text data that are not tagged including the determined categories to information regarding the set of text data in which positive cases are tagged.

The information extraction device described in Patent Literature 1 generates statistic criteria for determining the category from text data including a small number of positive cases as information extraction rules and applies the information extraction rules to new text data so as to extract new results. Then, the information extraction device inquires of the user whether the extraction results are correct/incorrect, accumulates extraction results as novel cases according to the answering results, and repeats these procedures. In doing so, when certainty factors can be added to extraction results, the cases having high degrees of certainty factor are adopted as positive cases without confirming with the user. Inquiry is made as to only the cases having low degrees of certainty factor to determine whether or not they are adopted as novel cases.

Patent Literature 2 describes an information extraction device comprising a database, a pattern extraction part, and a term extraction part. The database stores positive cases that are specific terms and text data. The pattern extraction part performs full-text search on the database for positive cases and extracts patterns appearing around multiple cases that are search results. The term extraction part performs full-text search on the database using the patterns extracted by the pattern extraction part and extracts expressions extracted by the patterns, calculates a score for each expression, and sorts the expressions in the descending order of score. Here, the term extraction part calculates a score for each expression using a value obtained by multiplying the ratio of input positive cases to expressions extracted by the patterns by a value resulting from dividing the number of input positive cases extracted by the patterns by the number of input positive cases.

Patent Literature 2 recites that the information extraction device extracts text data patterns from input positive cases and text data as information extraction rules, scores extraction results extracted by the information extraction rules, and uses the extraction results with bootstrap techniques for increasing positive cases.

Patent Literature 1: Unexamined Japanese Patent Application KOKAI Publication No. 2002-222083; and

Patent Literature 2: Unexamined Japanese Patent Application KOKAI Publication No. 2005-322120.

### DISCLOSURE OF INVENTION

However, the information extraction devices of Patent Literature 1 and 2 have the following problems. The first problem is that candidates for novel cases (also termed unknown cases) that are not found among existing cases cannot properly be selected in order to highly accurate information extraction rules. This is because in the above information extraction devices, information extraction rules generated based on existing cases are used for extraction so that existing cases are extracted. In order words, new extraction targets are not well taken into account in the above information extraction devices.

In the information extraction device described in Patent Literature 1, statistic criteria are generated as information extraction rules by learning from a set of text data in which positive cases are tagged. In other words, the information extraction rules are generated using the learning results through mechanical learning based on given cases. Therefore, even if the information extraction device applies the information extraction rules to unknown cases, correct deduction is not always made and effective reduction may not made.

In the information extraction device described in Patent Literature 2, even if the extraction results are selected using the above-described scores, the extraction results leading to bad cases (negative cases) cannot completely be eliminated. Therefore, the information extraction device may accumulate negative cases each time the bootstrap step is performed. Furthermore, the score is calculated absolutely for each information extraction rule and novel cases obtained by individual information extraction rules cannot properly be evaluated whether they are good or bad.

The second problem is high cost for evaluating novel case candidates (confirmation cost) in order to generate highly accurate information extraction rules. For example, when there are a large number of novel case candidates, the confirmation cost for novel case candidates is increased.

In the information extraction device described in Patent Literature 1, many cases are determined to have a low degree of certainty factor because of learning failure in spite of use of mechanical learning techniques supplying certainty factors along with extraction results. Therefore, the cases should be confirmed by the user. Furthermore, in this information extraction device, data about which inquiry is made of the user include a large amount of unnecessary data when effective deduction results are not obtained. Consequently, in this information extraction device, confirmation workload of the user is increased in order to select new positive cases, increasing confirmation cost.

The information extraction device described in Patent Literature 2 allows for confirmation by the user using scores. However, novel cases obtained only by the same information extraction rules all have the same score. Therefore, this information extraction device cannot clarify significant difference between novel cases. As in the information extraction device described in Patent Literature 1, inquiry has to be made of the user as to a large volume of unnecessary data, increasing confirmation workload of the user and confirmation cost.

A purpose of the present invention is to provide an information extraction device, information extraction method, and information extraction program that can properly select novel cases that are not found among known cases in order to generate highly accurate information extraction rules.

Another purpose of the present invention is to provide an information extraction system that can reduce conformation cost for evaluating novel case candidates that are not found among known cases in order to generate highly accurate information extraction rules.

The present invention provides an information extraction device for extracting specific information using information extraction rules, comprising a case candidate extraction means for extracting new specific information that is not extracted by the information extraction rules as novel case candidates based on extraction results obtained from extraction target text data; a rule candidate generation means for generating multiple extraction rule candidates based on the novel case candidates; a relation analysis means for analyzing the derivational relation between the novel case candidates and the extraction rule candidates and the overlapping relation between the multiple extraction rule candidates to generate relation analysis results; and

a case candidate selection means for calculating the priorities of the novel case candidates based on the relation analysis results and previously prepared case information and selecting the novel case candidates according to the priority.

The present invention further provides an information extraction system comprising an information extraction device connected to a user terminal via communication lines for extracting specific information using information extraction rules, wherein the information extraction device comprises a case candidate extraction means for extracting new specific information that is not extracted by the information extraction rules as novel case candidates based on extraction results obtained from extraction target text data; a rule candidate generation means for generating multiple extraction rule candidates based on the novel case candidates; a relation analysis means for analyzing the derivational relation between the novel case candidates and the extraction rule candidates and the overlapping relation between the multiple extraction rule candidates to generate relation analysis results;

a case candidate selection means for calculating the priorities of the novel case candidates based on the relation analysis results and previously prepared case information and selecting the novel case candidates according to the priority; and a case candidate inquiry means for inquiring of the user terminal about the correct/incorrect of novel case candidates selected by the case candidate selection means and giving the determination results from the user terminal to the case candidate selection means; the case candidate selection means determines the correct/incorrect of the selected novel case candidates based on the determination results given by the case candidate inquiry means.

The present invention further provides an information extraction method for extracting specific information using information extraction rules, comprising the flowing steps: extracting new specific information that is not extracted by the information extraction rules as novel case candidates based on extraction results obtained from extraction target text data; generating multiple extraction rule candidates based on the novel case candidates; analyzing the derivational relation between the novel case candidates and the extraction rule candidates and the overlapping relation between the multiple extraction rule candidates to generate relation analysis results; and calculating the priorities of the novel case candidates based on the relation analysis results and previously prepared case information and selecting the novel case candidates according to the priority.

The present invention further provides an information extraction program for an information extraction device provided with a computer and extracting specific information using information extraction rules, wherein the program allows the computer to perform the following procedures: extracting new specific information that is not extracted by the information extraction rules as novel case candidates based on extraction results obtained from extraction target text data; generating multiple extraction rule candidates based on the novel case candidates;

analyzing the derivational relation between the novel case candidates and the extraction rule candidates and the overlapping relation between the multiple extraction rule candidates to generate relation analysis results; and calculating the priorities of the novel case candidates based on the relation analysis results and previously prepared case information and selecting the novel case candidates according to the priority.

The information extraction device, information extraction method, and information extraction program of the present invention extract novel case candidates from information extraction rules and text data, generate multiple information extraction rule candidates from the novel case candidates, calculate the priorities of novel case candidates using the relation analysis results obtained by analyzing the derivational relation between novel case candidates and information extraction rule candidates and the overlapping relation between information extraction rule candidates and case information, and select novel case candidates according to the priority, whereby novel case candidates that are not found among known cases can properly be selected.

With the information extraction system of the present invention, novel case candidates about which inquiry is to be made of the user by the case candidate inquiry means are first selected as novel case candidates that are not found among known cases and then selected by the case candidate selection means according to the priority calculated for each novel case candidate based on relation analysis results and case information. Therefore, only properly selected novel case candidates are presented on the user terminal, reducing confirmation cost required for determining the correct/incorrect on the user terminal.

The above and other purpose, characteristics, and benefits of the present invention will be apparent from the explanation below with reference to the drawings.

### BRIEF DESCRIPTION OF DRAWINGS

FIG. 1A block diagram showing an information extraction device according to Embodiment 1 of the present invention;

FIG. 2 A flowchart showing the operation of the information extraction device shown in FIG. 1;

FIG. 3 A table showing exemplary case information;

FIG. 4 A table showing exemplary novel case candidates;

FIG. 5 A table showing the association between novel case candidates and generated information extraction rule candidates;

FIG. 6 A table showing the correspondence between information extraction rule candidates and extraction results;

FIG. 7 A diagram showing exemplary extraction results;

FIG. 8 A diagram showing a relation network;

FIG. 9 A table showing a part of the relation network shown in FIG. 8;

FIG. 10 A table showing the relation between novel case candidates and priorities;

FIG. 11 A block diagram showing an information extraction system including an information extraction device according to Embodiment 2 of the present invention;

FIG. 12 A flowchart showing the operation of the information extraction system shown in FIG. 11;

FIG. 13 A table showing exemplary inquiry information; and

FIG. 14 Exemplary contents on a novel case candidate determination screen.

### BEST MODE FOR CARRYING OUT THE INVENTION

Embodiments of the present invention will be described hereafter with reference to the drawings. The same elements are referred to by the same reference numbers throughout the figures.

### Embodiment 1

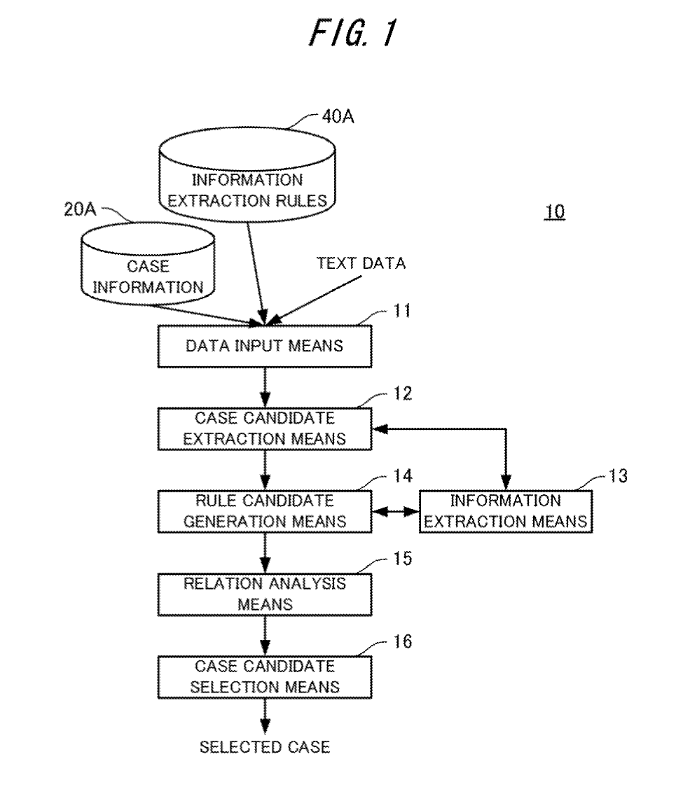

FIG. 1 is a block diagram showing an information extraction device according to Embodiment 1 of the present invention. An information extraction device 10 comprises a data input means (unit) 11, a case candidate extraction means 12, an information extraction means 13, a rule candidate generation means 14, a relation analysis means 15, and a case candidate selection means 16. With the above configuration, the information extraction device 10 selects cases used for generating information extraction rules that will be applied in extraction of specific information from a large volume of extraction target text data.

The information extraction device 10 is configured, for example, with a not-shown computer having a central processing unit (CPU) functioning as the above means 11 to 16. Furthermore, the information extraction device 10 is realized by storing in any recording medium programs that allow the central processing unit to perform the procedures as the above means 11 to 16, reading the programs into the main memory of the computer, and executing the read programs on the central processing unit. Input data and various output information are stored in the main memory or can be stored in separate magnetic disc memory devices and read for use. The above means 11 to 16 can be configured by dedicated hardware.

The functions of the above means 11 to 16 will be outlined hereafter for convenience of explanation. The data input means 11 receives information extraction rules, case information, and text data as input. When the input data volume is large, data can be stored in an appropriate storage device so that the data input means 11 reads them for reference when necessary. The case candidate extraction means 12 gives the information extraction rules and text data entered through the data input means 11 to the information extraction means 13 and receives extraction results obtained by the information extraction means 13 applying the information extraction rules to the text data. The case candidate extraction means 12 extracts from the text data multiple novel case candidates different from the extraction results based on the information of extraction results.

The rule candidate generation means 14 generates multiple information extraction rule candidates from the novel case candidates extracted by the case candidate extraction means 12. The relation analysis means 15 analyzes the derivational relation between novel case candidates and information extraction rule candidates and the overlapping (inclusive) relation between extraction results of individual information extraction rule candidates. The case candidate selection means 16 calculates the priorities of novel case candidates based on the relation analysis results by the relation analysis means 15 and the case information, selects novel case candidates, and outputs the results. Here, the case information is stored in a database 20A and the information extraction rules are stored in a database 40A. The database 40A is accessed by the case candidate extraction means 12 for making reference to stored information extraction rules, for example, when text data are entered into the data input means 11. The database 20A is accessed by the case candidate selection means 16 for making reference to stored case information, for example, upon calculation of the priorities.

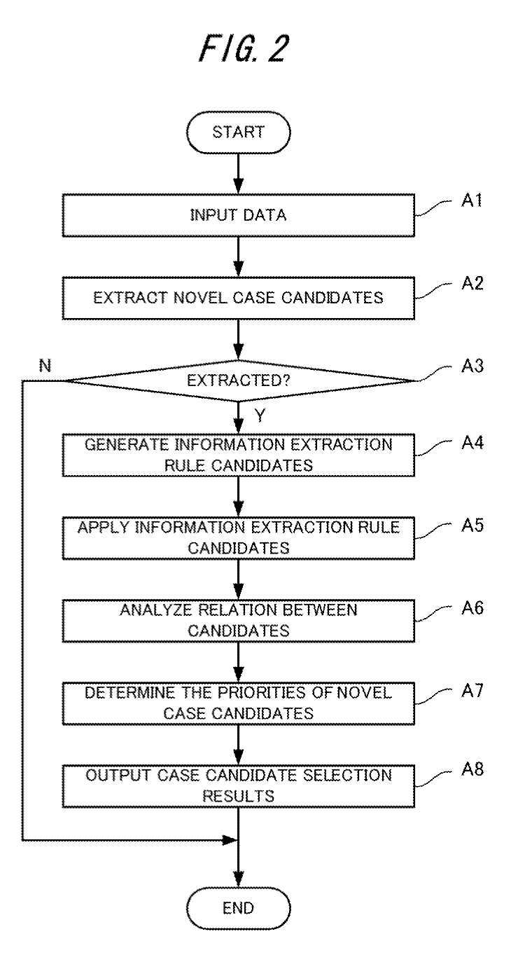

Operation of the information extraction device 10 will be described hereafter with reference to the flowchart shown in FIG. 2. The data input means 11 receives information extraction rules, case information, and text data as input and gives the input data to the case candidate extraction means 12 (Step A1).

Then, in Step A2, first, the case candidate extraction means 12 gives to the information extraction means 13 the information extraction rules and text data received by the data input means 11 and receives from the information extraction means 13 the extraction results obtained by the information extraction means 13 applying the information extraction rules to the text data. Then, the case candidate extraction means 12 generates extraction conditions based on the received extraction results. Subsequently, the case candidate extraction means 12 extracts from the text data the portions to which the extraction conditions apply and extracts multiple pieces of information different from the received extraction results as novel case candidates.

Then, the case candidate extraction means 12 determines whether or not any novel case candidates are extracted. When no extraction is made, the process ends (Step A3, N). When any extraction is made, the process proceeds to Step A4 (Step A3, Y). The rule candidate generation means 14 generates multiple information extraction rule candidates from the novel case candidates extracted by the case candidate extraction means 12 (Step A4).

In Step A5, first, the rule candidate generation means 14 gives the generated information extraction rule candidates to the information extraction means 13. The information extraction means 13 applies the information extraction rules candidates generated by the rule candidate generation means 14 to the text data to obtain extraction results and give them to the relation analysis means 15.

Step A6 will be described hereafter. First, the relation analysis means 15 analyzes the derivational relation between novel case candidates and information extraction rule candidates and the overlapping relation between extraction results of individual information extraction rule candidates, and generates a relation network in which the nodes consisting of the novel case candidates and information extraction rule candidates are connected by links presenting the relation between them. Then, the relation analysis means 15 associates the nodes of information extraction rule candidates with the extraction results extracted by the information extraction rule candidates and the case information to create relation network information, and gives it to the case candidate selection means 16 (Step A6). Here, the relation analysis means 15 determines that individual information extraction rule candidates are “related” and links them when an overlapping relation is found between the extraction results of these information extraction rule candidates obtained in Step A5.

Then, the case candidate selection means 16 calculates the priorities of the novel case candidates using the relation network information of the relation analysis results by the relation analysis means 15 and the case information (Step A7). Subsequently, the case candidate selection means 16 determines whether or not the cases should be selected based on the priorities, selects the novel case candidates, and outputs the results (Step A8).

The priorities are calculated by tracing links in the relation network for the set created by excluding the information extraction rule candidates determined to be unnecessary based on the case information from the set of information extraction rule candidates derived from novel case candidates and using the number of information extraction rule candidates within a specific reachable range, the number of positive cases extracted by the information extraction rule candidates, the largest number of passing links, and the like. The specific range reachable by tracing links in a relation network can be a range within which information extraction rule candidates of which the extraction results contain no negative case in the case information are reachable, a range in which the information extraction rule candidates yield extraction results containing negative cases at a specific ratio or less, or a range of specific number of paths.

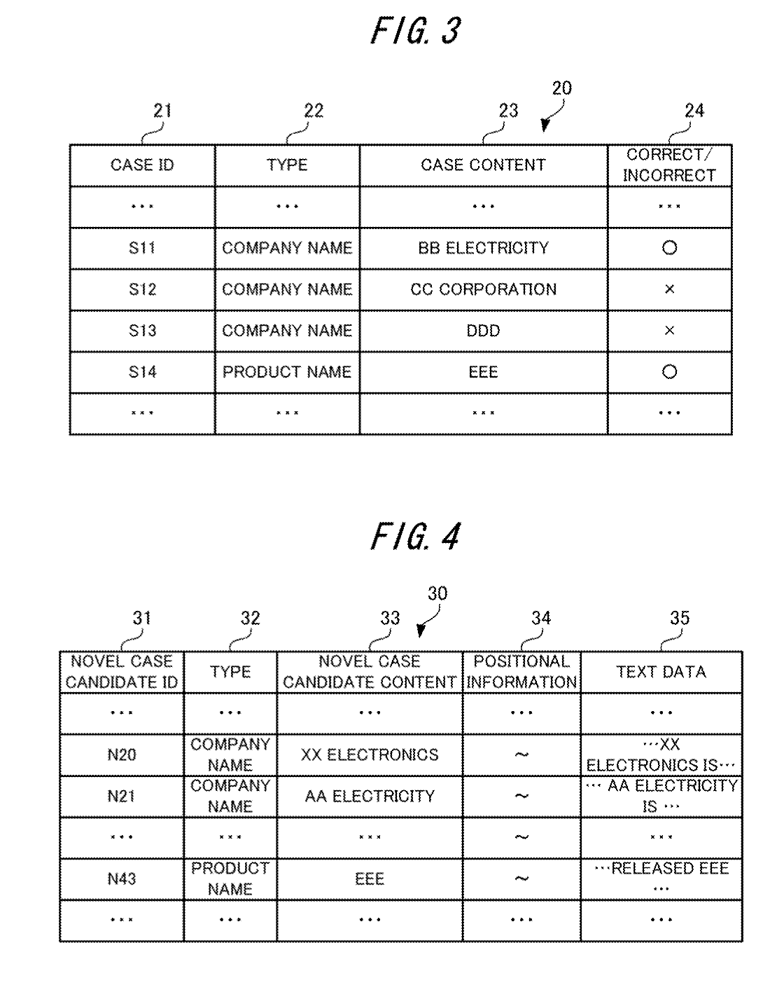

Operation of the information extraction device 10 will be described more specifically hereafter with reference to FIGS. 3 to 10. The data input means 11 receives entered information extraction riles, case information (see FIG. 3), and text data and gives them to the case candidate extraction means 12 (Step A1). The text data are extraction target data and can be, for example, data including text data such as various documents, HTML data obtained from Web sites, and electronic mail messages, or even data after some processing such as deletion of unnecessary symbols and sentence adjustment where necessary.

The information extraction rules are existing extraction rules applied in extracting specific information from extraction target text data and include, for example, pattern conditions such as character string, character type, morpheme information, and modification relation information and formats indicating information types. Furthermore, the information extraction rules are not restricted thereto and can be presented in various formats. For example, when a morpheme is followed by a character string “Co., Ltd.” as postposition, the morpheme is assumed to be a “company name” in a rule, which is presented using a pattern condition and an action in a format “IF (a pattern condition) THEN (an action).” The information extraction means 13 is configured to be able to interpret and apply these various formats.

FIG. 3 is a table showing exemplary case information. Case information 20 is prepared in advance in accordance with key words and the like given by the user and the like. As shown in the figure, associated with each case ID 21 indicating an individual case, a type 22, case content 23, and correct/incorrect information 24 indicating correct or incorrect are included. The correct/incorrect information 24 indicates whether or not the case content 23 is information suitable for extraction in accordance with the key word and the like. If it is “o,” the case information 20 is a positive case. If it is “x,” the case information 20 is a negative case. Here, the case information 20 includes negative cases because the possibility of selecting a positive case is eventually increased by not selecting a negative case for a given key word.

Then, the procedure in Step A2 will be described hereafter. The case candidate extraction means 12 gives to the information extraction means 13 the information extraction rules and text data received by the data input means 11 and receives from the information extraction means 13 the extraction results obtained by the information extraction means 13 applying the information extraction rules to the text data. The case candidate extraction means 12 generates extraction conditions for finding (searching for) novel case candidates from text data based on the received extraction results.

The extraction conditions are generated, for example, by using the contents of the received extraction results. In other words, the extraction conditions can be a character string in a specific portion among given text data and information different from the character strings in the case contents 23 of the case information 20. As an example, it is assumed that extraction target text data are “AA Electricity announced a new product,” some information extraction rules are applied to the text data, and a character string “AA Electricity” is obtained from the beginning as an extraction result. If this character string is not contained in the case information 20, this character string becomes an extraction condition. Referring to FIG. 3, the case contents 23 contain multiple character strings, “BB Electricity, CC Corporation, DDD, and EEE,” but do not contain the character string “AA Electricity.” Therefore, this character string becomes an extraction condition.

However, the above case is not restrictive. Using morphologic analysis results on text data, a combination of attribute values such as the word class, reading, character string of the original form, and thesaurus information of one or multiple morphemes to which the character string applies can be extraction conditions. For example, when the above character string “AA Electricity” is analyzed as a morpheme, the word class of the morpheme is “proper noun” or “organization,” the attribute value of the word class is used as an extraction condition. Any other combination of attribute values can be used as an extraction condition. Furthermore, it is possible to associate the extraction results with syntax analysis results and use the attribute values of elements of the syntax analysis results to which the character string in the extraction result contact applies or a combination of their attribute values as an extraction condition.

Then, the case candidate extraction means 12 extracts the portions to which the extraction condition applies from a large volume of text data and extracts multiple novel case candidates (see FIG. 4). Here, it is possible that the case candidate extraction means 12 extracts information resembling the extraction conditions, not the portions to which the extraction condition precisely applies, from the text data and assumes the found portions as novel case candidates. As an example, when an extraction condition consists of a character string, character strings in the text data that have an edit distance small or less than a specific distance from the character string of the extraction condition can be assumed to be novel case candidates. Here, the edit distance can be calculated by an existing method and its explanation is omitted.

Here, it is desirable that the case candidate extraction means 12 extracts as novel case candidates information different from the extraction results, in other words information that is not extracted by applying existing information extraction rules already entered. This is because using as novel case candidates the same information as the extraction results does not lead to improved accuracy of information extraction rules. Furthermore, it is desirable that the case candidate extraction means 12 excludes from novel case candidates information that is known to be unsuitable in advance, in other words a portion that conforms with any negative case even if an extraction condition or information resembling an extraction condition applies to the portion. This is because inclusion of a negative case in novel case candidates does not lead to improved accuracy of information extraction rules. Incidentally, when the case candidate extraction means 12 generates extraction conditions based on part of morphologic analysis results or syntax analysis results, the text data can be associated with the morphologic analysis results or syntax analysis results to extract the portions to which the extraction conditions apply in the text data.

FIG. 4 is a table showing exemplary information of novel case candidates. A novel case candidate 30 includes, as shown in the figure, a novel case candidate type 32, content 33, positional information 34 indicating the position in the text date, and text data 35, which are associated with a novel case candidate ID 31 that is an identifier of the novel case candidate 30. Here, the content 33 of the novel case candidate 30 includes character strings “XX Electronics, AA Electricity, and EEE.” The character string “AA Electricity” to which the extraction condition applies is included. Here, the text data 35 containing the content 33 of the novel case candidate 30 is used to generate an information extraction rule candidate and associated with a novel case candidate ID 31. Then, the case candidate extraction means 12 gives the information on the novel case candidates 30 to the rule candidate generation means 14. Since the novel case candidates 30 are extracted in the above Step A2 (Step A3, Y), the process proceeds to Step A4.

The procedure in Step S4 will be described hereafter. The rule candidate generation means 14 generates multiple information extraction rule candidates from the novel case candidates extracted by the case candidate extraction means 12. The rule candidate generation means 14 performs analysis procedures such as morphological analysis, syntax analysis, semantic analysis, and the like on the text data corresponding to the novel case candidates using existing language analysis techniques. Then, the rule candidate generation means 14 generates multiple extraction rule candidates in various existing formats using combinations of various patterns obtained from the analysis procedure results. Here, the novel case candidates and the generated information extraction rule candidates are associated as shown in FIG. 5.

FIG. 5 is a table showing exemplary association between novel case candidates and generated information extraction rule candidates. Here, associated with an information extraction rule candidate ID 41 that is an identifier indicating a specific information extraction rule candidate 40, an extraction rule content 42 and a novel case candidate ID 31 and type 32 of a novel case candidate 30 that is used for generating a specific information extraction rule candidate 40 (see FIG. 4) are shown in a table format as information on the information extraction rule candidates 40. However, this is not restrictive and any other format can be used.

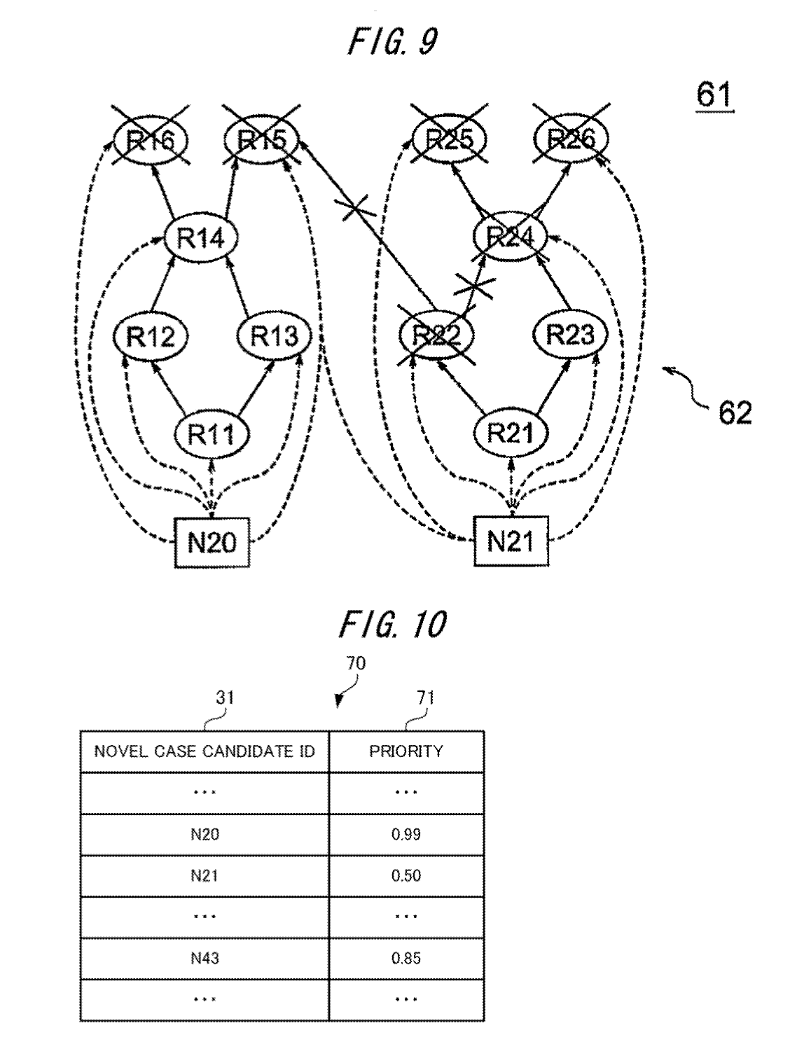

As described above, since the novel case candidate 30 indicated by the novel case candidate ID 31 and the information extraction rule candidate ID 41 are associated, the novel case candidate 30 that is used by the rule candidate generation means 14 for generating the information extraction rule candidate 40 is known. As an example, the novel case candidate 30 having a novel case candidate ID 31 of “N21” is associated with multiple information extraction rule candidates 40 having information extraction rule candidate IDs 41 of “R21” and “R24.” In other words, this association sets forth a derivational relation indicating from which novel case candidate 30 an information extraction rule candidate 40 is generated. The derivational relation is used by the relation analysis means 15 for linking the novel case candidate 30 and the information extraction rule candidate 40 to generate relation network information (see FIG. 9).

The procedure in Step A5 will be described hereafter. The rule candidate generation means 14 gives the generated information extraction rule candidates to the information extraction means 13. The information extraction means 13 applies the information extraction rule candidates to text data and obtains extraction results for each information extraction rule candidate.

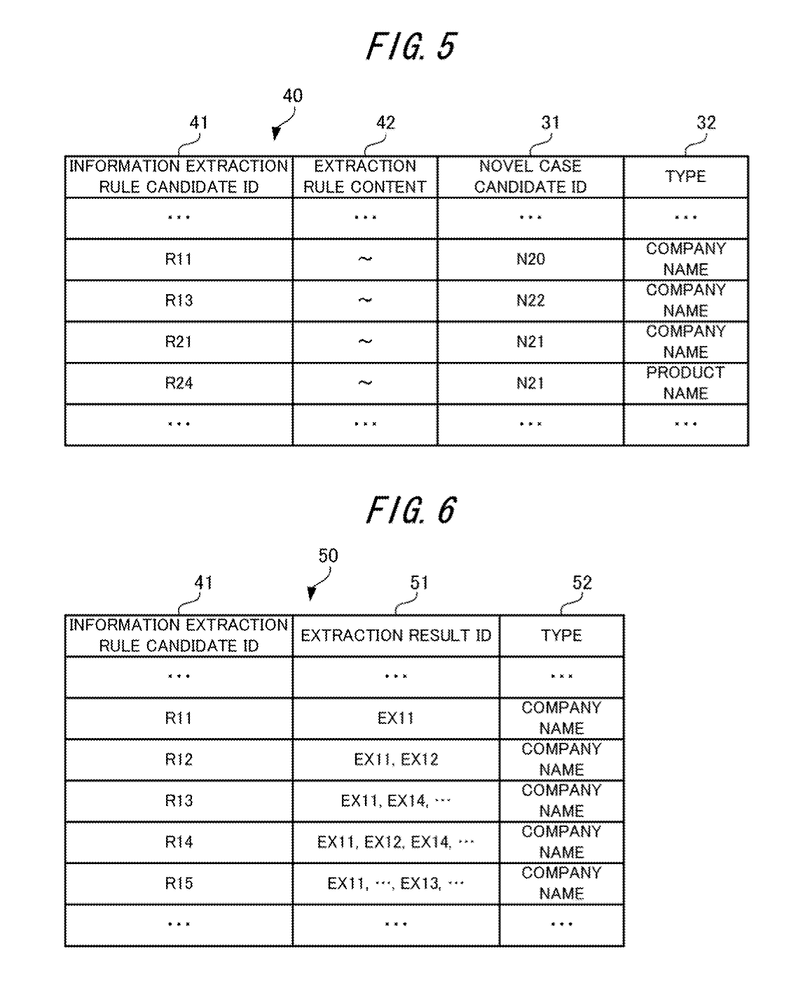

FIG. 6 is a table showing the correspondence between information extraction rule candidates and extraction results. Here, associated with an information extraction rule candidate ID 41, an extraction result ID 51 identifying an individual extraction result extracted and an extraction result type 52 are shown as information 50 showing the correspondence. The information extraction rule candidate 40 provides a more general condition and yields a larger number of extraction results as the information extraction rule candidate ID 41 has a higher value. On the other hand, the information extraction rule candidate 40 provides a more particular condition and yields a smaller number of extraction results as the information extraction rule candidate ID 41 has a lower value. As an example, the extraction results obtained by applying the information extraction rule candidate 40 having an information extraction rule candidate ID 41 of “R11” to text data include only “EX11” shown in the extraction result ID 51. On the other hand, the extraction results obtained by applying the information extraction rule candidate having an information extraction rule candidate ID 41 of “R15” include multiple results “EX11, . . . , EX13, . . . .” Furthermore, it is understood that the type 52 of these extraction results is “company name.”

Furthermore, by associating the information extraction rule candidate ID 41 with the extraction result ID 51, the inclusive relation between multiple information extraction rule candidates indicating that the extraction results by one information extraction rule candidate 40 are included in the extraction result by the other information extraction rule candidate 40 and the overlapping relation indicating that the extraction results by one information extraction rule candidate overlap with the extraction results by the other information extraction rule candidate are shown. The overlapping relation is used by the relation analysis means 15 for linking multiple information extraction rule candidates to generate relation network information (see FIG. 9).

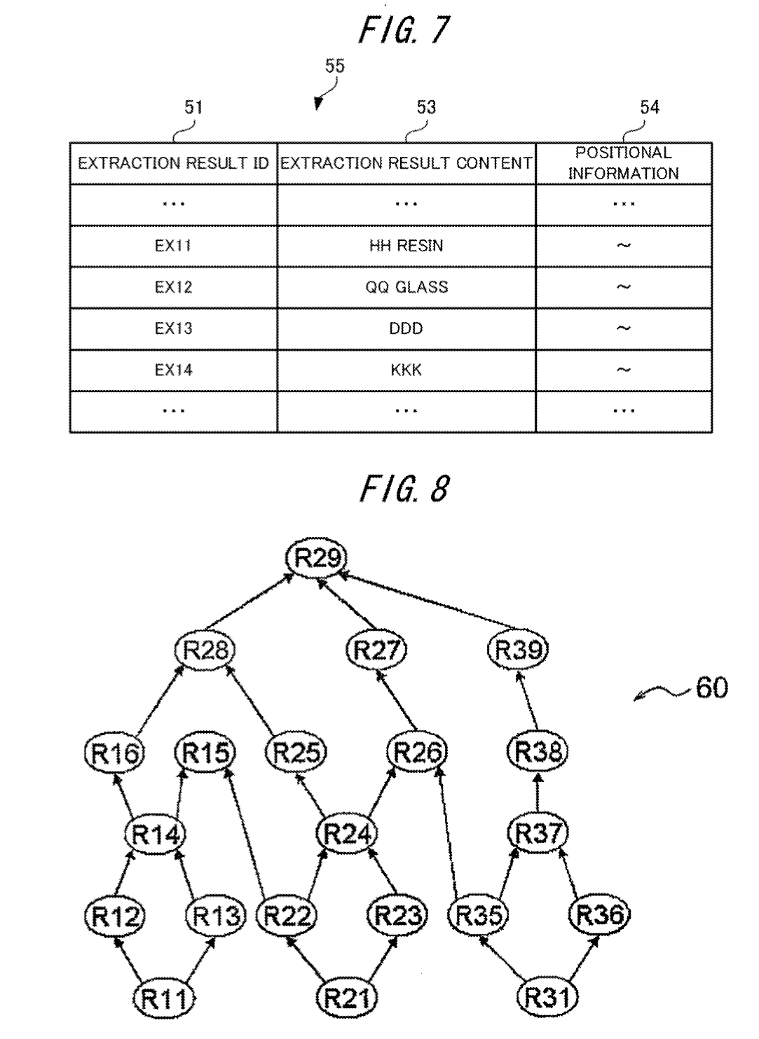

FIG. 7 is a table showing the association between the extraction result contents and positional information corresponding to the extraction result IDs shown in FIG. 6. Here, associated with an extraction result ID 51, an extraction result content 53 and positional information 54 are shown as information 55 showing their association. The positional information 54 is information indicating from what position in which text data the extraction is made. When the text data is controlled by documents, for example, a document ID identifying the document and an offset value from the beginning indicating the position in the document ID can be used. In another example, a document is controlled by sentences and a sentence ID identifying the sentence in the document identified by a document ID and an offset value within the sentence ID can be used. In a further other example, in place of the extraction result content and positional information, tags allowing for identification of text data and extraction results can be inserted in the text data to associate with information such as the extraction result ID 51 and type 52.

Then, the procedure in Step A6 will be described hereafter. The relation analysis means 15 analyzes the derivational relation between the novel case candidates 30 and information extraction rule candidates 40 shown in FIG. 5 and further analyzes the overlapping relation between the extraction results of individual information result rule candidates 40 shown in FIG. 6. Subsequently, the relation analysis means 15 generates a relation network 60 shown in FIG. 8 by linking the nodes consisting of the novel case candidates 30 and information extraction rule candidates 40 based on their derivational relation and overlapping relation, and gives it to the case candidate selection means 16 as relation network information.

FIG. 8 is a diagram showing an exemplary relation network. In the figure, the circled nodes represent the information extraction rule candidates 40 derived and generated from not-shown novel case candidates. Here, the information extraction rule candidate IDs 41 are shown. Furthermore, the nodes of information extraction rule candidates 40 are connected by a directed link (which is simply termed “link”) when the extraction results of two information extraction rule candidates have an overlapping relation.

However, the relation between extraction results of individual information extraction rule candidates 40 can be an inclusive relation instead of an overlapping relation. As an example, a comparison is made between the extraction result by the information extraction rule candidate 40 having an information extraction rule candidate ID 40 of “R11” and the extraction result by the information extraction rule candidate 40 having an information extraction rule candidate ID 40 of “R12” in FIG. 6. In this case, the “R11” leads to an extraction result ID 51 of “EX11” and the “R12” leads to extraction result IDs 51 of “EX11, EX12.” Therefore, the extraction result by the information extraction rule candidate 40 of “R12” includes the extraction result by the information extraction rule candidate 40 of “R11.” Then, the relation analysis means 15 establishes a link between these information extraction rule candidates 40 based on this inclusive relation. However, this is not restrictive. It is possible that no link is established when the degree of overlapping between information extraction rule candidates 40 is low and their relation is weak and a link is established only when the degree of overlapping is higher than a given value. The relation network information can be generated as appropriate as information indicating such nodes and links.

The procedures in Steps A7 and A8 will be described hereafter. The case candidate selection means 16 calculates the priorities of novel case candidates using the relation network information obtained based on the relation analysis results by the relation analysis means 15 and the case information 20. Here, it is assumed that the relation network 60 shown in FIG. 8 is obtained for extracting company names. In this case, the case candidate selection means 16 compares information 50 and 55 relating to the extraction results shown in FIGS. 6 and 7 with the case information 20 shown in FIG. 3. The case candidate selection means 16 determines that an information extraction rule candidate 40 is unnecessary when the extraction result content 53 of the information extraction rule candidate 40 includes an improper type of extraction result (for example, the content 53 is not “a company name”) or a negative case (the correct/incorrect information 24 is “x”). However, it is possible that the case candidate selection means 16 does not determine that an information extraction rule candidate 40 is unnecessary not only when the extraction results by the information extraction rule candidate 40 include no negative case but also when, for example, the ratio of negative cases to all extraction results is a given value or lower so as not to reduce the number of information extraction rule candidates 40 used for calculating the priorities.

FIG. 9 is a diagram showing a part of the relation network shown in FIG. 8. Here, as an example, a relation network 61 is shown as a first set consisting of multiple information extraction rule candidates 40 derived from the novel case candidates 30 indicated by novel case candidates IDs “N20” and “N21.” In FIG. 9, the links presented by solid lines are directed links generated as “related” when there is an overlapping relation.

Furthermore, in FIG. 9, the links presented by broken lines are links generated when the novel case candidate 30 and information extraction rule candidate 40 have a derivational relation. For example, it is known from the relation between the novel case candidates 30 and information extraction rule candidates 40 shown in FIG. 5 that the information extraction rule candidate ID 41 of “R11” is generated from the novel case candidate ID 31 of “N20” and they have a derivational relation. In FIG. 9, a connection is made by a broken line link from the novel case candidate ID 31 of “N20” to the information extraction rule candidate ID D41 of “R11.” Here, the extraction results obtained by applying the information extraction rule candidate 40 having an information extraction rule candidate ID 41 of “R15” included in the relation network 61 to text data include an extraction result ID 51 of “EX13.” The extraction result content 53 of the “EX13” is “DDD” as shown in FIG. 7, which conforms with the case content 23 of the case ID 21 of“S13” shown in FIG. 3 that is determined to be a negative case by the correct/incorrect information 24. In other words, the information extraction rule candidate 40 having an information extraction rule candidate ID 41 of “R15” is determined to be unnecessary. Furthermore, it is assumed that the information extraction rule candidates 40 having information extraction rule candidate IDs 41 of “R16” and “R22” include in their extraction results the case contents 23 that are determined to be a negative case.

In this case, the novel case candidate 30 having a novel case candidate ID 31 of “N20” derives and spreads to the information extraction rule candidates 40 having information extraction rule candidate IDs 41 of “R11,” “R12,” “R13,” and “R14.” However, the novel case candidate 30 having a novel case candidate ID 31 of “N21” derives and spreads to nothing but the information extraction rule candidates 40 having information extraction rule candidate IDs 41 of “R21” and “R23.” In other words, upon tracing the relation network 16, the case candidate selection means 16 stops the tracing once it finds an information extraction rule candidate 40 including in its extraction result any case content 23 that is determined to be a negative case. The links that is not need to be traced are marked by a symbol “x” in the figure.

As described above, the case candidate selection means 16 generates a second set 62 by excluding the information extraction rule candidates 40 that include a negative case based on the correct/incorrect information 24 of the case information 20 and therefore are determined to be unnecessary from multiple information extraction rule candidates 40 included in the relation network 61 as the first set and calculates the priority using the second set 62.

The priority can be calculated, for example using the number of derived information extraction rule candidates 40 included in the second set 62, the total number of unique extraction results extracted by the information extraction rule candidates 40 that are derived from the novel case candidates 30 and not unnecessary, the number of unique extraction results extracted by all information extraction rule candidates 40, and the largest number of passing link to an information extraction rule candidates 40 from the node of a novel case candidate 30. The priority can be calculated, for example, by weighting and multiplying these numbers. The unique extraction results are extraction results that are extracted only by an information extraction rule candidate when a comparison is made between the extraction results extracted by an information extraction rule candidate and the extractions results extracted by another information extraction rule candidate.

The priority will be described more specifically hereafter. When the number of information extraction rule candidates 40 included in the second set 62 is used as the priority, as shown in FIG. 9, the priority of the novel case candidate having a novel case candidate ID “N20” is calculated to be “4” and the priority of the novel case candidate having a novel case candidate ID “N21” is calculated to be “2.” Alternatively, the total number of unique extraction results extracted by the information extraction rule candidates 40 that are derived from a novel case candidate 30 and not unnecessary can be used as the priority. In such a case, as shown in FIG. 9, by tracing the links indicating inclusive relation, it is understood that the number of extraction results by the information extraction rule candidate having an information extraction rule candidate ID “R14” includes the extraction results of “R11,” “R12,” and “R13.” Therefore, the priority of the novel case candidate ID “N20” is calculated to be the number of extraction results by “R14” and, similarly, the priority of the novel case candidate ID “N21” is calculated to be the number of extraction results by “R23.”

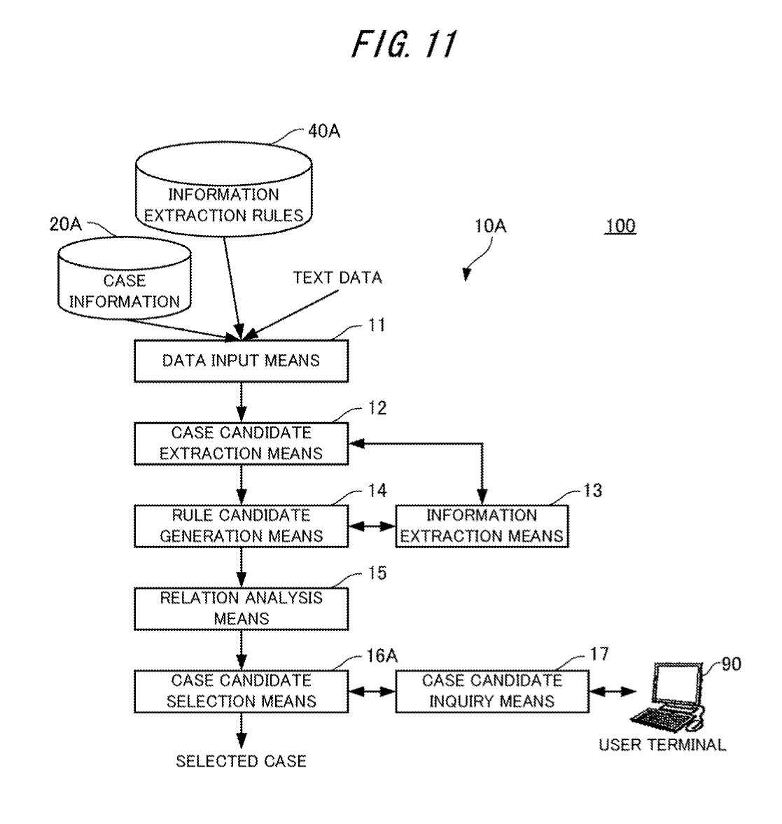

Furthermore, it is assumed that the largest number of passing links to an information extraction rule candidate 40 from the node of a novel case candidate 30 is used as the priority. In such a case, as shown in FIG. 9, by tracing the links between nodes of the relation network, the priority of the novel case candidate ID “N20” is calculated to be the number of passing links “3” from the node of a novel case candidate ID “N20” to the node of an information extraction rule candidate ID. “R14.” Furthermore, the priority of the novel case candidate ID “N21” is calculated to be the number of passing links “2” from the node of a novel case candidate ID “N21” to the node of an information extraction rule candidate ID “R23.” The above priorities can be divided by the highest value for normalization so that the priorities are presented as a calibrated value. FIG. 10 shows the correspondence between novel case candidates and priorities. Here, values 71 indicating the priorities normalized for a value between 0 and 1 are shown for each novel case candidate ID 31 as information 70 indicating the correspondence.

In the information extraction device 10 of this embodiment, with information extraction rules, case information 20, and text data being entered into the data input means 11, novel case candidates 30 that are not extracted by the information extraction rules and not included in the case information are extracted and information extraction rule candidates 40 are generated from the novel case candidates 30. Then, the mutual relations between the novel case candidates 30 and information extraction rule candidates 40 are analyzed to generate a relation network 60. The priorities of the novel case candidates 30 are calculated from the relation network information and case information 20. Furthermore, the novel case candidates 30 are selected according to the priority. In this way, novel case candidates can properly be selected.

### Embodiment 2

FIG. 11 is a block diagram showing an exemplary information extraction system including an information extraction device according to Embodiment 2 of the present invention. The parts having the same functions as those of the information extraction device 10 of Embodiment 1 and therefore leading to duplicated explanation will be excluded from explanation below as appropriate. An information extraction system 100 comprises a user terminal 90 and an information extraction device 10A connected to the user terminal 90 via communication lines. The information extraction device 10A is different from the information extraction device 10 of Embodiment 1 primarily in that a case candidate inquiry means 17 is added. Here, the central processing unit of a computer also functions as the case candidate inquiry means 17.

The case candidate inquiry means 17 extracts novel case candidates about which inquiry is to be made according to the priorities of novel case candidates determined by a case candidate selection means 16A, generates inquiry information including the extracted novel case candidates, and transmits the generated inquiry information to the user terminal 90. The user terminal 90 is a device including a proper display means and input means. For example, the user terminal 90 presents a novel case candidate extracted from the inquiry information, receives a correct/incorrect determination result from the user, and transmits the determination result to the case candidate inquiry means 17. Receiving the correct/incorrect determination result, the case candidate inquiry means 17 sends the determination result to the case candidate selection means 16A. Using the determination result on the extracted novel case candidate and the above-described relation network information, the case candidate selection means 16A further deduces the correct/incorrect as to other novel case candidates if determination is possible and outputs the final results.

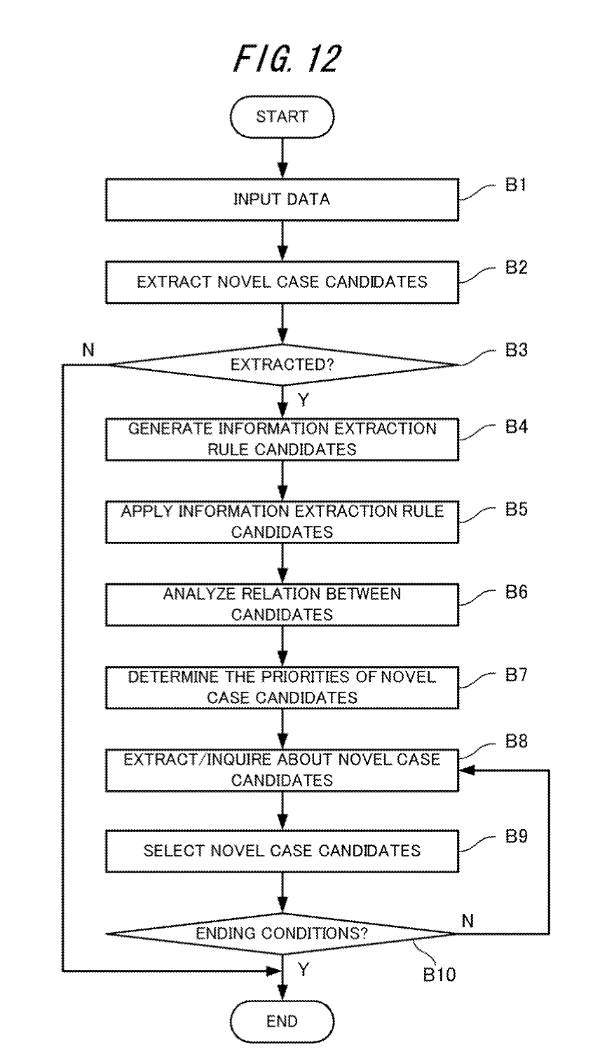

Operation of the information extraction system 100 including the information extraction device 10A will be described hereafter with reference to the flowchart shown in FIG. 12. In the figure, the procedures in Steps B1 to B7 are the same as those in Steps A1 to A7 shown in FIG. 2. Therefore, the explanation of Steps B1 to B7 is omitted and Steps B8 to B10 will be described hereafter. In the information extraction device 10 of Embodiment 1, the case candidate selection means 16 calculates the priorities of novel case candidates using the relation network information and case information. On the other hand, in the information extraction device 10A of this embodiment, after the priorities of novel case candidates are calculated in Step B7, the case candidate inquiry means 17 further selects novel case candidates about which inquiry is to be made of the user based on the priorities and makes inquiry (Step B8).

The case candidate inquiry means 17 generates inquiry information on the selected novel case candidates, presents it on the user terminal 90, receives correct/incorrect determination results from the user terminal 90, and gives them to the case candidate selection means 16A. Based on the received determination results and relation network information, the case candidate selection means 16A further deduces the determination results as to other novel case candidates if determination is possible and makes selections (Step B9). After Step B9, it is determined whether or not the ending conditions are satisfied such as whether there is any undetermined novel case candidate (Step B10). When satisfied, the process ends (Step B10, Y). When there is any undetermined novel case candidate (Step B10, N), the process returns to Step B8 and the above procedure is repeated.

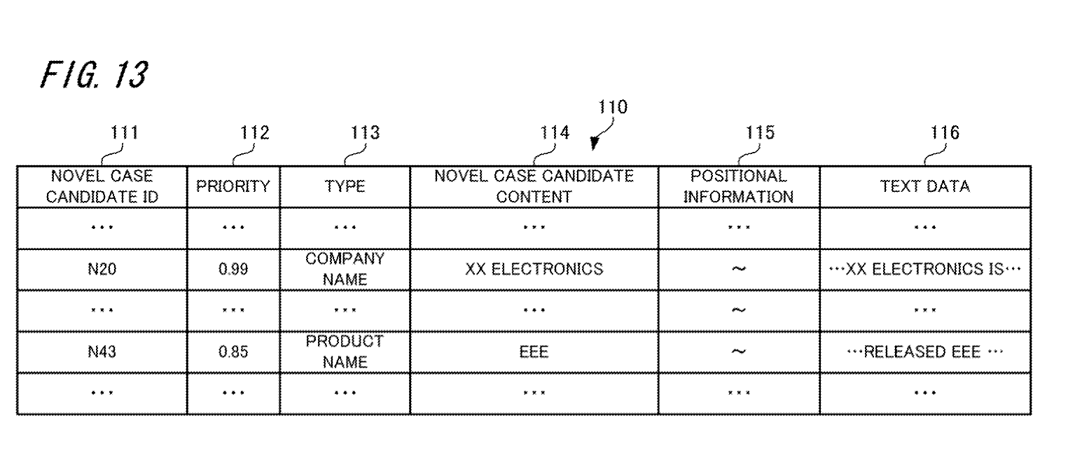

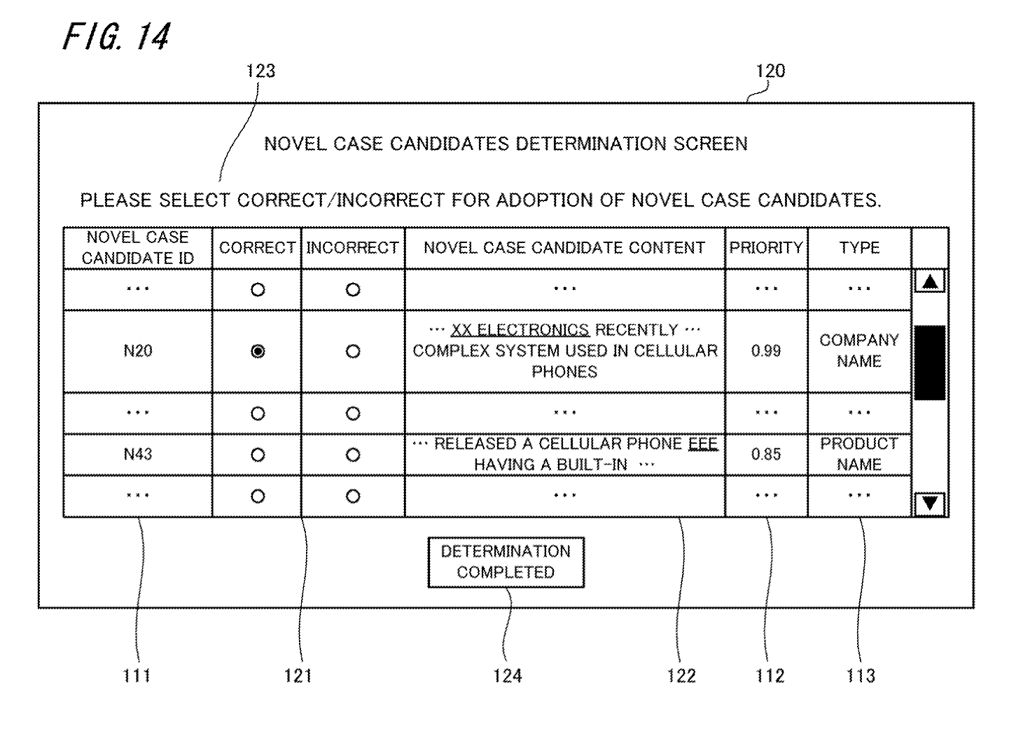

Operation of the information extraction system 100 including the information extraction device 10A will be described more specifically hereafter with reference to FIGS. 13 and 14. In Step B8, the case candidate inquiry means 17 extracts novel case candidates about which inquiry is to be made using the priorities of novel case candidates determined by the case candidate selection means 16A, generates inquiry information including the extracted novel case candidates, and transmits the generated inquiry information to the user terminal 90. Here, the novel case candidates about which inquiry is to be made are extracted, for example, by extracting novel case candidates having a priority higher than a predetermined value so as to exclude novel case candidates having lower priorities. This is not restrictive. A given number of novel case candidates or a given percent of novel case candidates can be extracted from those having higher priorities. Furthermore, in consideration of those having higher priorities highly possibly being extracted and those having lower priorities highly possibly being rejected, novel case candidates having a priority in a given value range can be extracted so as to extract novel cases that are not easy to automatically extract.

The inquiry information transmitted to the user terminal 90 sufficiently includes at least one or more novel case candidates. Furthermore, in order to reduce the number of presentation on the user terminal 90, the inquiry information can include multiple novel case candidates at a time. Furthermore, the inquiry information can include, as supplementary information for supporting determination, information such as the priorities calculated for each novel case candidate, text data and positional information from which the novel case candidates are extracted, and types indicating the type of information. FIG. 13 is a table showing exemplary inquiry information. Here, inquiry information 110 includes a priority 112, a type 113, novel case candidate content 114, and text data 116 and their positional information 115, which are associated with a novel case candidate ID 111.

The user terminal 90 can be a personal computer or the like as long as at least an input means such as a keyboard and an output means such as a display are provided. The user terminal 90 presents novel case candidates from the inquiry information 110 received from the case candidate inquiry means 17 and receives the entry of correct/incorrect determination results.

FIG. 14 shows an exemplary screen display for presentation of novel case candidates. The user terminal 90 displays a novel case candidate determination screen 120 as shown in the figure. Associated with each novel case candidate ID 111, a check box 121 for entering a correct/incorrect determination result, novel case candidate information 122, and a priority 112 and type 113 as supplementary information are displayed on the novel case candidate determination screen 120. A message 123 for urging the user to determine correct/incorrect is also displayed on the novel case candidate determination screen 120. Here, the novel case candidate information 122 shows original text data from which italicized or underlined novel case candidate content 114 is extracted.

The user terminal 90 receives a correct/incorrect determination result for each novel case candidate 111 given by making a selection in the check box 121. Receiving the entry through a determination completion button 124, the correct/incorrect determination results corresponding to the novel case candidates ID 111 are transmitted to the case candidate inquiry means 17.

The procedures in Steps B9 and B10 will be described hereafter. Receiving the correct/incorrect determination results corresponding to the novel case candidates ID 111, the case candidate inquiry means 17 gives the correct/incorrect determination results to the case candidate selection means 16A. Using the received determination results corresponding to the novel case candidates and the relation network information, the case candidate selection means 16A further deduces the correct/incorrect as to other novel case candidates if determination is possible and outputs the final results.

The information extraction system 100 including the information extraction device 10A of this embodiment selects novel case candidates about which inquiry is to be made of the user using the priorities calculated based on the relation network and presents only the properly selected novel case candidates on the user terminal 90. Consequently, it is unnecessary for the user to confirm all novel case candidates, reducing confirmation cost.

It is possible in the information extraction device 10 or 10A of the above embodiments that the case candidate selection means 16 or 16A selects proper novel case candidates, the selected novel case candidates are further evaluated, for example, using given thresholds in the procedures of Steps A8 or B9 and subsequent steps, and optimum or superior novel case candidates are entered into the data input means 11 as case information in Steps A1 or B1. Additionally or instead, it is possible that new information extraction rules are generated by applying existing language analysis techniques to the above selected novel case candidates and the newly generated information extraction rules are entered into the data input means 11 in Step A1 or B1. With the results obtained in the procedures in Step A8 or B9 and subsequent steps being reflected in Step A1 or B1 as described above, the accuracy of novel case candidates selected from the information extraction device 10 or 10A can be improved.

The information extraction device 10 or 10A and information extraction system 100 of the above embodiments are not restricted to devices for selecting cases used in generating information extraction rules for extracting specific information from extraction target text date. For example, other applications include information extraction rule creation devices for generating new information extraction rules by using extracted novel cases at low cost, information endorsement devices configured by using the above information extraction device, and information search devices for finding specific information.

The information extraction device of the present invention can have the following modes.

The case candidate extraction means generates extraction conditions for extracting novel case candidates from text data based on extraction results. In this case, the extraction conditions can be generated, for example, as information that is extracted from text data and is not included in case information prepared in advance.

The extraction conditions consist of attribute values of one or multiple morphemes to which a character string obtained as an extraction result applies or their combination. In this case, the extraction conditions can be not only simply a character string in text data but also the word class, reading, character string of the original form, thesaurus information, and the like obtained from the morphological analysis results of a character string.

The case information includes correct/incorrect information indicating whether or not the content is information suitable for extraction. The case candidate extraction means excludes a specified portion in text data when the specified portion conforms with any case information of which the correct/incorrect information is incorrect. In this way, even if it is extracted by any extraction conditions, the specified portion that conforms with any negative case is excluded from novel case candidates, whereby the accuracy of extraction rule candidates generated by the rule candidate generation means can be improved.

The rule candidate generation means associates a novel case candidate to each generated extraction rule candidate and generates a derivational relation. In this case, from which novel case candidate an extraction rule candidate is generated is shown.

The overlapping relation is a relation indicating whether or not at least part of the extraction results by one extraction rule candidate include the extraction results by the other extraction rune candidate. An information extraction means associating the extraction results extracted from text data according to the extraction rule candidates received from the rule candidate generation means to each extraction rule candidate to generating an overlapping relation is further provided. In this case, the inclusive relation indicating whether or not the extraction results by one extraction rule candidate include the extraction results by the other extraction rule candidate is also shown as an overlapping relation.

The relation analysis means generates relation network information linking novel case candidates and extraction rule candidates satisfying a derivational relation and linking extraction rule candidates satisfying an overlapping relation. In this way, the derivational relation, inclusive relation, and overlapping relation are reflected in the relation network information.

The relation network information includes a first set consisting of multiple extraction rule candidates satisfying a derivational relation and overlapping relation. The case candidate selection means generates a second set by excluding the extraction rule candidates of which the extraction results extracted by the information extraction means are case information of which the correct/incorrect information is incorrect from multiple extraction rule candidates included in the first set, and uses the second set to calculate the priority. In this case, with the second set being generated by excluding the extraction rule candidates yielding extraction results that are negative cases from multiple extraction rule candidates included in the first set, the priority can be calculated based on highly reliable extraction rule candidates.

The case candidate selection means can be configured to calculate the priority using the number of extraction rule candidates or the number of extraction results extracted from text data according to the extraction rule candidates included in the second set. For example, calculation can be done to yield a higher priority as the number of extraction rule candidates or extraction results is larger.

The case candidate selection means can be configured to calculate the priority using the number of links or the largest number of passing links in the second set. For example, calculation can be done to yield a higher priority as the number of links or the largest number of passing links is larger.

The present invention is specifically illustrated and described with reference to exemplary embodiments above. The present invention is not confined to the above embodiments and their modifications. As apparent to a person of ordinary skill in the field, various modifications can be made to the present invention without departing from the spirit and scope of the present invention set forth in the attached claims.

This application claims the benefit of Japanese Patent Application No. 2008-000685, filed on Jan. 7, 2008, the entire disclosure of which is incorporated by reference herein.

1. An information extraction device for extracting specific information using information extraction rules, comprising:
a case candidate extraction unit for extracting new specific information that is not extracted by said information extraction rules as novel case candidates based on extraction results obtained from extraction target text data;
a rule candidate generation unit for generating multiple extraction rule candidates based on said novel case candidates;
a relation analysis unit for analyzing the derivational relation between said novel case candidates and said extraction rule candidates and the overlapping relation between said multiple extraction rule candidates to generate relation analysis results; and
a case candidate selection unit for calculating the priorities of said novel case candidates based on said relation analysis results and previously prepared case information and selecting said novel case candidates according to the priority.

2. The information extraction device according to claim 1 wherein said case candidate extraction unit generates extraction conditions for extracting said novel case candidates from said text data based on said extraction results.

3. The information extraction device according to claim 2 wherein said extraction conditions are attribute values of one or multiple morphemes to which a character string obtained as said extraction results applies or a combination of such attribute values.

4. The information extraction device according to claim 3 wherein said case information includes correct/incorrect information indicating whether or not the content of case information is information suitable for extraction; and
said case candidate extraction unit excludes a specified portion in said text data from said novel case candidates when the specified portion conforms with any case information of which the correct/incorrect information is incorrect.

5. The information extraction device according to claim 1 wherein said rule candidate generation unit generates said derivational relation by associating said novel case candidates with each of said generated extraction rule candidates.

6. The information extraction device according to claim 4 wherein said overlapping relation is a relation indicating whether or not at least part of the extraction results by one extraction rule candidate includes the extraction results by the other extraction rule candidate; and
said information extraction device further comprises an information extraction unit associating the extraction results extracted from said text data according to said extraction rule candidates given by said rule candidate generation unit with each of said extraction rule candidates to generate said overlapping relation.

7. The information extraction device according to claim 6 wherein said relation analysis unit generates relation network information linking between said novel case candidates and extraction rule candidates satisfying said derivational relation and between said extraction rule candidates satisfying said overlapping relation.

8. The information extraction device according to claim 7 wherein said relation network information includes a first set consisting of multiple extraction rule candidates satisfying said derivational relation and overlapping relation; and
said case candidate selection unit generates a second set by excluding the extraction rule candidates of which the extraction results extracted by said information extraction unit conform with any case information of which said correct/incorrect information is incorrect from multiple extraction rule candidates included in said first set, and calculates said priorities using said second set.

9. The information extraction device according to claim 8 wherein said case candidate selection unit calculates said priorities using the number of said extraction rule candidates or the number of extraction results extracted from said text data according to said extraction rule candidates in said second set.

10. The information extraction device according to claim 8 wherein said case candidate selection unit calculates said priorities using the number of links or the largest number of passing links in said second set.

11. An information extraction system comprising an information extraction device connected to a user terminal via communication lines for extracting specific information using information extraction rules, wherein
said information extraction device comprises:
a case candidate extraction unit for extracting new specific information that is not extracted by said information extraction rules as novel case candidates based on extraction results obtained from extraction target text data;
a rule candidate generation unit for generating multiple extraction rule candidates based on said novel case candidates;
a relation analysis unit for analyzing the derivational relation between said novel case candidates and said extraction rule candidates and the overlapping relation between said multiple extraction rule candidates to generate relation analysis results;
a case candidate selection unit for calculating the priorities of said novel case candidates based on said relation analysis results and previously prepared case information and selecting said novel case candidates according to the priority; and
a case candidate inquiry unit for inquiring of said user terminal about the correct/incorrect of novel case candidates selected by said case candidate selection unit and giving the determination results from said user terminal to said case candidate selection unit;
said case candidate selection unit determines the correct/incorrect of said selected novel case candidates based on said determination results given by said case candidate inquiry unit.

12. An information extraction method for extracting specific information using information extraction rules, comprising the flowing steps:
extracting new specific information that is not extracted by said information extraction rules as novel case candidates based on extraction results obtained from extraction target text data;
generating multiple extraction rule candidates based on said novel case candidates;
analyzing the derivational relation between said novel case candidates and said extraction rule candidates and the overlapping relation between said multiple extraction rule candidates to generate relation analysis results; and
calculating the priorities of said novel case candidates based on said relation analysis results and previously prepared case information and selecting said novel case candidates according to the priority.

13. The information extraction method according to claim 12 wherein said case information includes correct/incorrect information indicating whether or not the content of case information is information suitable for extraction; and
in said step of extracting, a specified portion in said text data is excluded from said novel case candidates when the specified portion conforms with any case information of which the correct/incorrect information is incorrect.

14. The information extraction method according to claim 13 wherein in said step of generating relation analysis results, relation network information linking between said novel case candidates and extraction rule candidates satisfying said derivational relation and between said extraction rule candidates satisfying said overlapping relation is generated; and
said relation network information includes a first set consisting of multiple extraction rule candidates satisfying said derivational relation and overlapping relation, and
in said step of selecting said novel case candidates, a second set is generated by excluding the extraction rule candidates of which the extraction results include any case information of which said correct/incorrect information is incorrect from multiple extraction rule candidates included in said first set and said second set is used to calculate said priorities.

15. The information extraction method according to claim 12 wherein said information extraction method further comprises the following steps:
inquiring of a user terminal about the correct/incorrect determination of said selected novel case candidates; and
receiving the determination results indicating said correct/incorrect determination from said user terminal and determining the correct/incorrect of said selected novel case candidates based on said determination results.

16. A recording medium storing an information extraction program for an information extraction device provided with a computer and extracting specific information using information extraction rules, wherein said program allows said computer to perform the following procedures:
extracting new specific information that is not extracted by said information extraction rules as novel case candidates based on extraction results obtained from extraction target text data;
generating multiple extraction rule candidates based on said novel case candidates;
analyzing the derivational relation between said novel case candidates and said extraction rule candidates and the overlapping relation between said multiple extraction rule candidates to generate relation analysis results; and
calculating the priorities of said novel case candidates based on said relation analysis results and previously prepared case information and selecting said novel case candidates according to the priority.

17. The recording medium according to claim 16 wherein said case information includes correct/incorrect information indicating whether or not the content of case information is information suitable for extraction; and
in said procedure of extracting, a specified portion in said text data is excluded from said novel case candidates when the specified portion conforms with any case information of which the correct/incorrect information is incorrect.

18. The recording medium according to claim 17 wherein in said procedure of generating relation analysis results, relation network information linking between said novel case candidates and extraction rule candidates satisfying said derivational relation and between said extraction rule candidates satisfying said overlapping relation is generated; and
said relation network information includes a first set consisting of multiple extraction rule candidates satisfying said derivational relation and overlapping relation, and
in said procedure of selecting said novel case candidates, a second set is generated by excluding the extraction rule candidates of which the extraction results include any case information of which said correct/incorrect information is incorrect from multiple extraction rule candidates included in said first set, and said second set is used to calculate said priorities.

19. The recording medium according to claim 16 wherein said program further allows said computer to perform the following procedures:
inquiring of a user terminal about the correct/incorrect determination of said selected novel case candidates; and
receiving the determination results indicating said correct/incorrect determination from said user terminal and determining the correct/incorrect of said selected novel case candidates based on said determination results.
